(19) United States
(12) Patent Application Publication
(10) Pub. No.: US 2025/0315596 A1
(43) Pub. Date: Oct. 9, 2025

(54) METHODS, APPARATUSES AND COMPUTER PROGRAM PRODUCTS FOR FACILITATING CONTEXTUAL TEXT SUMMARIZATION OF RESOURCES IN SYSTEMS

(71) Applicant: META PLATFORMS, INC., Menlo Park, CA (US)

(72) Inventor: Ziliu Li, Redmond, WA (US)

(21) Appl. No.: 18/627,256

(22) Filed: Apr. 4, 2024

(51) Int. Cl. G06F 40/166; G06N 20/00

(52) U.S. Cl. CPC G06F 40/166; G06N 20/00

(57) ABSTRACT

A system and method for generating summaries of a resource(s) are provided. The system may analyze a resource(s), associated with a user, being input/captured by a user interface. The resource(s) may be sharable among users of a group. The system may implement a machine learning model including training data pre-trained, or trained in real-time, on summaries of resources as a same or similar type as the resource(s), one or more content items associated with content of the resource(s), or user interaction historical data. The system may automatically determine a suggested summary, of the resource(s), tailored to the user in response to determining interests or focuses of the user based in part on analyzing the user interaction historical data. The system may present, by a user interface or a display device, the suggested summary of the resource(s).

### TECHNOLOGICAL FIELD

Exemplary aspects of this disclosure may relate generally to methods, apparatuses and computer program products for providing techniques that facilitate efficient and reliable mechanisms to provide context-aware summaries for resources which may generate different summaries of the resources associated with different contexts corresponding to different users to enhance focus and to express interested key points or topics associated with the different users.

### BACKGROUND

In some existing applications (apps), such as for instance social apps, content or media sharing and posting may be an important channel for content generation in a system. A common scenario associated with some existing apps may involve sharing the content from external resources (e.g., posts, news, papers, etc.) which may drive discussion in the system.

Additionally, some existing systems may generate a snapshot from an original source as a brief summary for an external resource. However, these approaches may provide limited information associated with the sharing of posts for users. For instance, the user may need to click and read through the original media or data of an external resource to learn or figure out whether there is any useful knowledge or information the user may be interested in, which may be time-consuming, less efficient and cumbersome for users.

Other existing systems that may employ text-to-summary generation techniques may suffer from the drawback of the summary of an external resource being generated statically. For instance, these text-to-summary generation techniques may generate the summary of the same external resource to be the same summary in each instance of creating the summary for the external resource. As such, the summary of the external resource may typically be the same for each of the users associated with the system.

However, the sharing of resources in different contexts (e.g. topics) may have different focuses and interest points which may not be able to be fulfilled with these existing text-to-summary generation systems and approaches.

As such, it may be beneficial to provide efficient and reliable mechanisms that provide context-aware summaries for resources which may generate different summaries associated with different contexts to enhance focus and to express interested key points for different audiences.

### BRIEF SUMMARY

Some examples of the present disclosure may provide techniques and mechanisms that facilitate efficient and reliable approaches to provide context-aware summaries (e.g., text summaries) for resources which may generate different summaries of the resources associated with different contexts corresponding to different users to enhance focus and to express interested key points or topics associated with the different users. In some examples, the different users may, but need not, be part of different groups or sets of users (e.g., different user audiences).

Some exemplary aspects of the present disclosure may provide a machine learning model and/or artificial intelligence model that may determine or predict summaries (e.g., textual summaries) of resources and may be trained based, in part, on contextual data such as, for example, user interaction historical data, one or more determined topics/subjects of communications and/or one or more determinations about content of the resource itself as one or more inputs to the machine learning model/artificial intelligence model. The machine learning model may utilize the contextual data and/or the determinations about the content of the resource itself to determine a context associated with a user or set/group of users associated with a post or publication (e.g., within or associated with an app) of a resource to generate a user specific/tailored summary of the resource. Additionally, for the same resource, the machine learning model may generate a different summary of the resource based, in part, on determining a different set of contextual data associated with, for example, a different user and/or a different set of users. In this regard, the exemplary aspects of the present disclosure may generate personalized or user-specific tailored summaries of resources.

In one example of the present disclosure, a method is provided. The method may include analyzing at least one resource, associated with a user, being input or captured by a user interface. The at least one resource may be sharable among one or more other users of a group. The method may further include implementing a machine learning model including training data pre-trained, or trained in real-time, on one or more summaries of resources as a same or similar type as the at least one resource, one or more content items associated with content of the at least one resource, or user interaction historical data. The method may further include automatically determining at least one suggested summary, of the at least one resource, tailored to the user in response to determining one or more interests or focuses of the user based in part on analyzing the user interaction historical data. The method may further include presenting, by a user interface or a display device, the at least one suggested summary of the at least one resource.

In another example of the present disclosure, an apparatus is provided. The apparatus may include one or more processors and a memory including computer program code instructions. The memory and computer program code instructions are configured to, with at least one of the processors, cause the apparatus to at least perform operations including analyzing at least one resource, associated with a user, being input or captured by a user interface. The at least one resource may be sharable among one or more other users of a group. The memory and computer program code are also configured to, with the processor(s), cause the apparatus to implement a machine learning model including training data pre-trained, or trained in real-time, on one or more summaries of resources as a same or similar type as the at least one resource, one or more content items associated with content of the at least one resource, or user interaction historical data. The memory and computer program code are also configured to, with the processor(s), cause the apparatus to automatically determine at least one suggested summary, of the at least one resource, tailored to the user in response to determining one or more interests or focuses of the user based in part on analyzing the user interaction historical data. The memory and computer program code are also configured to, with the processor(s), cause the apparatus to present, by a user interface or a display device, the at least one suggested summary of the at least one resource.

In yet another example of the present disclosure, a computer program product is provided. The computer program product may include at least one non-transitory computer-readable medium including computer-executable program code instructions stored therein. The computer-executable program code instructions may include program code instructions configured to analyze at least one resource, associated with a user, being input or captured by a user interface. The at least one resource may be sharable among one or more other users of a group. The computer program product may further include program code instructions configured to implement a machine learning model including training data pre-trained, or trained in real-time, on one or more summaries of resources as a same or similar type as the at least one resource, one or more content items associated with content of the at least one resource, or user interaction historical data. The computer program product may further include program code instructions configured to automatically determine at least one suggested summary, of the at least one resource, tailored to the user in response to determining one or more interests or focuses of the user based in part on analyzing the user interaction historical data. The computer program product may further include program code instructions configured to present, by a user interface or a display device, the at least one suggested summary of the at least one resource.

Additional advantages will be set forth in part in the description which follows or may be learned by practice. The advantages will be realized and attained by means of the elements and combinations particularly pointed out in the appended claims. It is to be understood that both the foregoing general description and the following detailed description are exemplary and explanatory only and are not restrictive, as claimed.

### BRIEF DESCRIPTION OF THE DRAWINGS

The summary, as well as the following detailed description, is further understood when read in conjunction with the appended drawings. For the purpose of illustrating the disclosed subject matter, there are shown in the drawings exemplary embodiments of the disclosed subject matter; however, the disclosed subject matter is not limited to the specific methods, compositions, and devices disclosed. In addition, the drawings are not necessarily drawn to scale. In the drawings:

FIG. 1 is a diagram of an exemplary network environment in accordance with an example of the present disclosure.

FIG. 2 is a diagram of an exemplary communication device in accordance with an example of the present disclosure.

FIG. 3 is a diagram of an exemplary computing system in accordance with an example of the present disclosure.

FIG. 4A is a diagram illustrating a generated summary of a resource(s) in accordance with exemplary aspects of the present disclosure.

FIG. 4B is a diagram illustrating another generated summary of a same or similar resource(s) associated with a resource(s) of FIG. 4A in accordance with exemplary aspects of the present disclosure.

FIG. 5A is a diagram illustrating a generated summary of a resource(s) in accordance with exemplary aspects of the present disclosure.

FIG. 5B is a diagram illustrating another generated summary of a same or similar resource(s) associated with a resource(s) of FIG. 5A in accordance with exemplary aspects of the present disclosure.

FIG. 5C is yet another diagram illustrating another generated summary of a same or similar resource(s) associated with a resource(s) of FIG. 5A and/or FIG. 5B in accordance with exemplary aspects of the present disclosure.

FIG. 6 illustrates an example of a machine learning framework in accordance with one or more examples of the present disclosure.

FIG. 7 illustrates an example flowchart illustrating operations for generating a summary of a resource(s) in accordance with an example of the present disclosure.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

Some embodiments of the present invention will now be described more fully hereinafter with reference to the accompanying drawings, in which some, but not all embodiments of the invention are shown. Indeed, various embodiments of the invention may be embodied in many different forms and should not be construed as limited to the embodiments set forth herein. Like reference numerals refer to like elements throughout. As used herein, the terms “data,” “content,” “information” and similar terms may be used interchangeably to refer to data capable of being transmitted, received and/or stored in accordance with embodiments of the invention. Moreover, the term “exemplary”, as used herein, is not provided to convey any qualitative assessment, but instead merely to convey an illustration of an example. Thus, use of any such terms should not be taken to limit the spirit and scope of embodiments of the invention.

As defined herein a “computer-readable storage medium,” which refers to a non-transitory, physical or tangible storage medium (e.g., volatile or non-volatile memory device), may be differentiated from a “computer-readable transmission medium,” which refers to an electromagnetic signal.

As referred to herein, a Metaverse may denote an immersive virtual space or world in which devices may be utilized in a network in which there may, but need not, be one or more social connections among users in the network or with an environment in the virtual space or world. A Metaverse or Metaverse network may be associated with three-dimensional (3D) virtual worlds, online games (e.g., video games), one or more content items such as, for example, images, videos, non-fungible tokens (NFTs) and in which the content items may, for example, be purchased with digital currencies (e.g., cryptocurrencies) and other suitable currencies. In some examples, a Metaverse or Metaverse network may enable the generation and provision of immersive virtual spaces in which remote users may socialize, collaborate, learn, shop and/or engage in various other activities within the virtual spaces, including through the use of Augmented/Virtual/Mixed Reality.

As referred to herein, a resource(s), or an external resource(s) may refer to any entity or source that may be accessed by a program or system that may be running, executed or implemented on a communication device and/or a network. Some examples of resources may include, but are not limited to, HyperText Markup Language (HTML) pages, web pages, images, videos, scripts, stylesheets, other types of files (e.g., multimedia files) that may be accessible via a network (e.g., the Internet) as well as other files that may be locally stored and/or accessed by communication devices.

It is to be understood that the methods and systems described herein are not limited to specific methods, specific components, or to particular implementations. It is also to be understood that the terminology used herein is for the purpose of describing particular embodiments only and is not intended to be limiting.

### Exemplary System Architecture

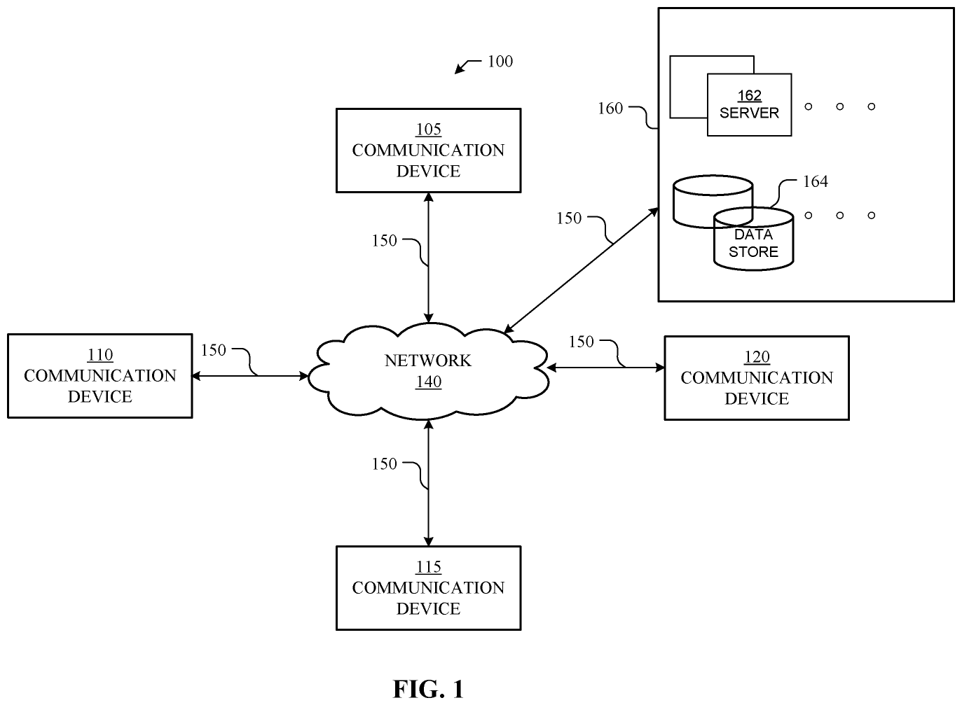

Reference is now made to FIG. 1, which is a block diagram of a system according to exemplary embodiments. As shown in FIG. 1, the system 100 may include one or more communication devices 105, 110, 115 and 120 and a network device 160. Additionally, the system 100 may include any suitable network such as, for example, network 140. In some examples, the network 140 may be a Metaverse network. In other examples, the network 140 may be any suitable network capable of provisioning content and/or facilitating communications among entities within, or associated with the network. As an example and not by way of limitation, one or more portions of network 140 may include an ad hoc network, an intranet, an extranet, a virtual private network (VPN), a local area network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, or a combination of two or more of these. Network 140 may include one or more networks 140.

Links 150 may connect the communication devices 105, 110, 115 and 120 to network 140, network device 160 and/or to each other. This disclosure contemplates any suitable links 150. In some exemplary embodiments, one or more links 150 may include one or more wireline (such as for example Digital Subscriber Line (DSL) or Data Over Cable Service Interface Specification (DOCSIS)), wireless (such as for example Wi-Fi or Worldwide Interoperability for Microwave Access (WiMAX)), or optical (such as for example Synchronous Optical Network (SONET) or Synchronous Digital Hierarchy (SDH)) links. In some exemplary embodiments, one or more links 150 may each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link 150, or a combination of two or more such links 150. Links 150 need not necessarily be the same throughout system 100. One or more first links 150 may differ in one or more respects from one or more second links 150.

In some exemplary embodiments, communication devices 105, 110, 115, 120 may be electronic devices including hardware, software, or embedded logic components or a combination of two or more such components and capable of carrying out the appropriate functionalities implemented or supported by the communication devices 105, 110, 115, 120. As an example, and not by way of limitation, the communication devices 105, 110, 115, 120 may be a computer system such as for example a desktop computer, notebook or laptop computer, netbook, a tablet computer (e.g., a smart tablet), e-book reader, Global Positioning System (GPS) device, camera, personal digital assistant (PDA), handheld electronic device, cellular telephone, smartphone, smart glasses, augmented/virtual reality device, smart watches, charging case, or any other suitable electronic device, or any suitable combination thereof. The communication devices 105, 110, 115, 120 may enable one or more users to access network 140. The communication devices 105, 110, 115, 120 may enable a user(s) to communicate with other users at other communication devices 105, 110, 115, 120.

Network device 160 may be accessed by the other components of system 100 either directly or via network 140. As an example and not by way of limitation, communication devices 105, 110, 115, 120 may access network device 160 using a web browser or a native application associated with network device 160 (e.g., a mobile social-networking application, a messaging application, another suitable application, or any combination thereof) either directly or via network 140. In particular exemplary embodiments, network device 160 may include one or more servers 162. Each server 162 may be a unitary server or a distributed server spanning multiple computers or multiple datacenters. Servers 162 may be of various types, such as, for example and without limitation, web server, news server, mail server, message server, advertising server, file server, application server, exchange server, database server, proxy server, another server suitable for performing functions or processes described herein, or any combination thereof. In particular exemplary embodiments, each server 162 may include hardware, software, or embedded logic components or a combination of two or more such components for carrying out the appropriate functionalities implemented and/or supported by server 162. In particular exemplary embodiments, network device 160 may include one or more data stores 164. Data stores 164 may be used to store various types of information. In particular exemplary embodiments, the information stored in data stores 164 may be organized according to specific data structures. In particular exemplary embodiments, each data store 164 may be a relational, columnar, correlation, or other suitable database. Although this disclosure describes or illustrates particular types of databases, this disclosure contemplates any suitable types of databases. Particular exemplary embodiments may provide interfaces that enable communication devices 105, 110, 115, 120 and/or another system (e.g., a third-party system) to manage, retrieve, modify, add, or delete, the information stored in data store 164.

Network device 160 may provide users of the system 100 the ability to communicate and interact with other users. In particular exemplary embodiments, network device 160 may provide users with the ability to take actions on various types of items or objects, supported by network device 160. In particular exemplary embodiments, network device 160 may be capable of linking a variety of entities. As an example and not by way of limitation, network device 160 may enable users to interact with each other as well as receive content from other systems (e.g., third-party systems) or other entities, or to allow users to interact with these entities through an application programming interfaces (API) or other communication channels.

It should be pointed out that although FIG. 1 shows one network device 160 and four communication devices 105, 110, 115 and 120, any suitable number of network devices 160 and communication devices 105, 110, 115 and 120 may be part of the system of FIG. 1 without departing from the spirit and scope of the present disclosure.

### Exemplary Communication Device

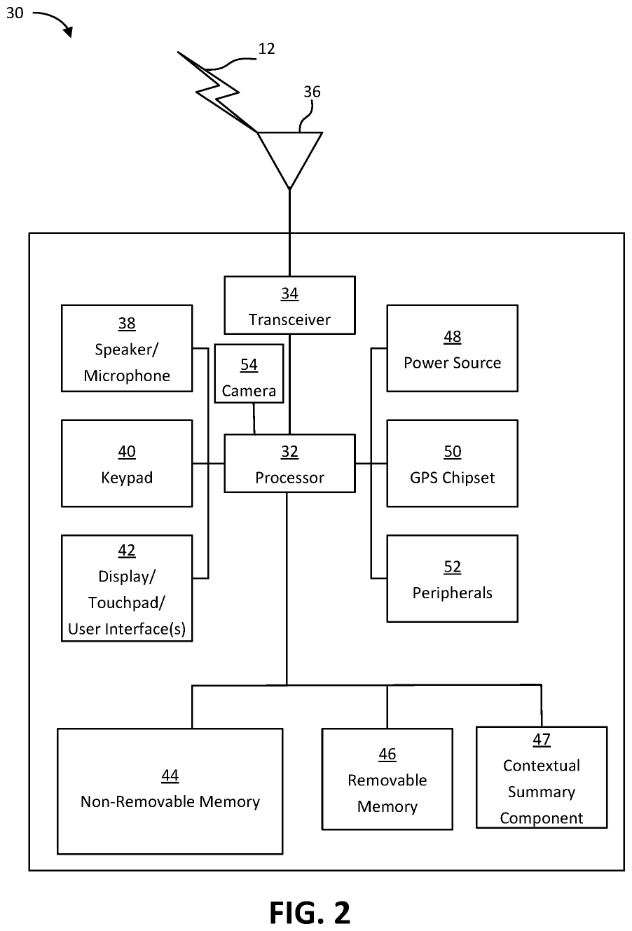

FIG. 2 illustrates a block diagram of an exemplary hardware/software architecture of a communication device such as, for example, user equipment (UE) 30. In some exemplary aspects, the UE 30 may be any of communication devices 105, 110, 115, 120. In some exemplary aspects, the UE 30 may be a computer system such as for example a desktop computer, notebook or laptop computer, netbook, a tablet computer (e.g., a smart tablet), e-book reader, GPS device, camera, personal digital assistant, handheld electronic device, cellular telephone, smartphone, smart glasses, augmented/virtual reality device, smart watch, charging case, or any other suitable electronic device. As shown in FIG. 2, the UE 30 (also referred to herein as node 30) may include a processor 32, non-removable memory 44, removable memory 46, a speaker/microphone 38, a keypad 40, a display, touchpad, and/or user interface(s) 42, a power source 48, a global positioning system (GPS) chipset 50, and other peripherals 52. In some exemplary aspects, the display, touchpad, and/or user interface(s) 42 may be referred to herein as display/touchpad/user interface(s) 42. The display/touchpad/user interface(s) 42 may include a user interface capable of presenting one or more content items and/or capturing input of one or more user interactions/actions associated with the user interface. The power source 48 may be capable of receiving electric power for supplying electric power to the UE 30. For example, the power source 48 may include an alternating current to direct current (AC-to-DC) converter allowing the power source 48 to be connected/plugged to an AC electrical receptable and/or Universal Serial Bus (USB) port for receiving electric power. The UE 30 may also include a camera 54. In an exemplary embodiment, the camera 54 may be a smart camera configured to sense images/video appearing within one or more bounding boxes. The UE 30 may also include communication circuitry, such as a transceiver 34 and a transmit/receive element 36. It will be appreciated the UE 30 may include any sub-combination of the foregoing elements while remaining consistent with an embodiment.

The processor 32 may be a special purpose processor, a digital signal processor (DSP), a plurality of microprocessors, one or more microprocessors in association with a DSP core, a controller, a microcontroller, Application Specific Integrated Circuits (ASICs), Field Programmable Gate Array (FPGAs) circuits, any other type of integrated circuit (IC), a state machine, and the like. In general, the processor 32 may execute computer-executable instructions stored in the memory (e.g., non-removable memory 44 and/or removable memory 46) of the node 30 in order to perform the various required functions of the node. For example, the processor 32 may perform signal coding, data processing, power control, input/output processing, and/or any other functionality that enables the node 30 to operate in a wireless or wired environment. The processor 32 may run application-layer programs (e.g., browsers) and/or radio access-layer (RAN) programs and/or other communications programs. The processor 32 may also perform security operations such as authentication, security key agreement, and/or cryptographic operations, such as at the access-layer and/or application layer for example.

The processor 32 is coupled to its communication circuitry (e.g., transceiver 34 and transmit/receive element 36). The processor 32, through the execution of computer executable instructions, may control the communication circuitry in order to cause the node 30 to communicate with other nodes via the network to which it is connected.

The transmit/receive element 36 may be configured to transmit signals to, or receive signals from, other nodes or networking equipment. For example, in an exemplary embodiment, the transmit/receive element 36 may be an antenna configured to transmit and/or receive radio frequency (RF) signals. The transmit/receive element 36 may support various networks and air interfaces, such as wireless local area network (WLAN), wireless personal area network (WPAN), cellular, and the like. In yet another exemplary embodiment, the transmit/receive element 36 may be configured to transmit and/or receive both RF and light signals. It will be appreciated that the transmit/receive element 36 may be configured to transmit and/or receive any combination of wireless or wired signals.

The transceiver 34 may be configured to modulate the signals that are to be transmitted by the transmit/receive element 36 and to demodulate the signals that are received by the transmit/receive element 36. As noted above, the node 30 may have multi-mode capabilities. Thus, the transceiver 34 may include multiple transceivers for enabling the node 30 to communicate via multiple radio access technologies (RATs), such as universal terrestrial radio access (UTRA) and Institute of Electrical and Electronics Engineers (IEEE 802.11), for example.

The processor 32 may access information from, and store data in, any type of suitable memory, such as the non-removable memory 44 and/or the removable memory 46. For example, the processor 32 may store session context in its memory, (e.g., non-removable memory 44 and/or removable memory 46) as described above. The non-removable memory 44 may include RAM, ROM, a hard disk, or any other type of memory storage device. The removable memory 46 may include a subscriber identity module (SIM) card, a memory stick, a secure digital (SD) memory card, and the like. In other exemplary embodiments, the processor 32 may access information from, and store data in, memory that is not physically located on the node 30, such as on a server or a home computer.

The processor 32 may receive power from the power source 48, and may be configured to distribute and/or control the power to the other components in the node 30. The power source 48 may be any suitable device for powering the node 30. For example, the power source 48 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like. The processor 32 may also be coupled to the GPS chipset 50, which may be configured to provide location information (e.g., longitude and latitude) regarding the current location of the node 30. It will be appreciated that the node 30 may acquire location information by way of any suitable location-determination method while remaining consistent with an exemplary embodiment.

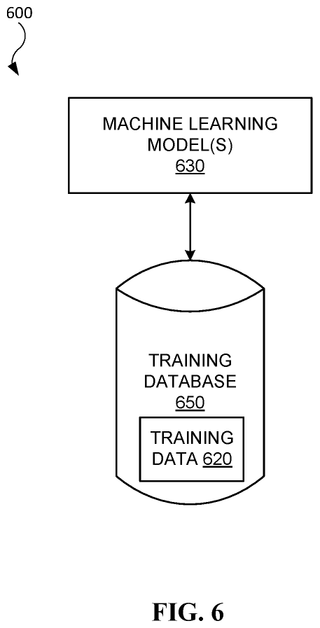

The UE 30 may also include a contextual summary component 47 that may automatically determine and present one or more generated summaries (e.g., textual summaries) of a resource(s). In some examples, the contextual summary component 47 may generate different summaries of a same resource based on determining different contexts corresponding to different users which may enhance the focus and express interested key points that the different users may be interested in for the associated resource(s). In some examples, the contextual summary component 47 may implement a machine learning model (e.g., machine learning model(s) 630 of FIG. 6) that may be pre-trained, and/or trained in real-time, with training data (e.g., training data 620 of FIG. 6) to determine the one or more generated summaries associated with a resource(s), as described more fully below.

### Exemplary Computing System

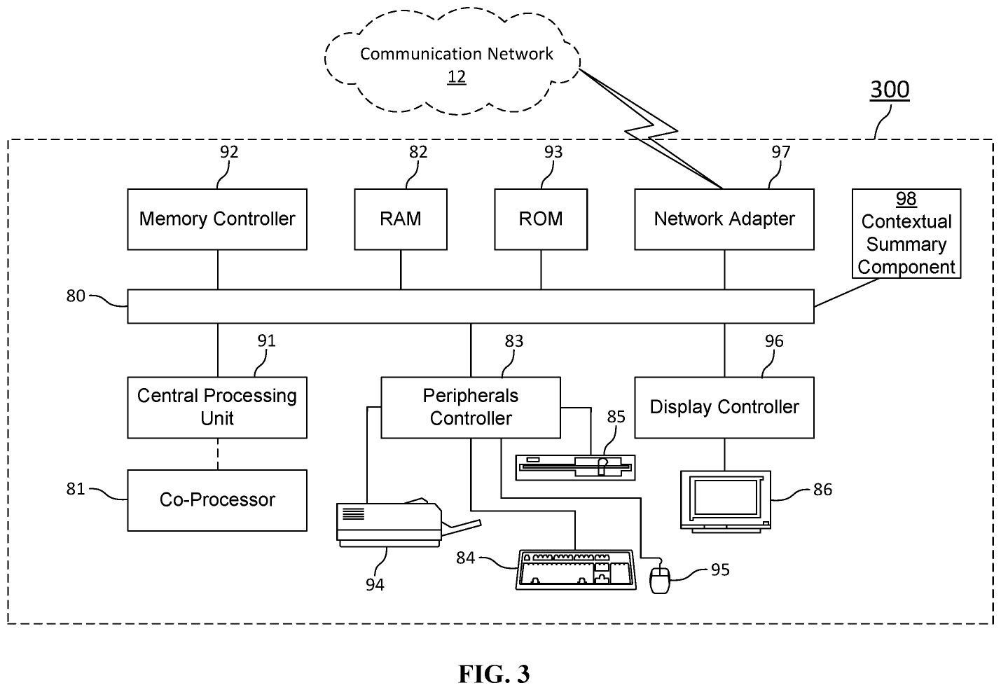

FIG. 3 is a block diagram of an exemplary computing system 300. In some exemplary embodiments, the network device 160 may be a computing system 300. The computing system 300 may comprise a computer or server and may be controlled primarily by computer readable instructions, which may be in the form of software, wherever, or by whatever means such software is stored or accessed. Such computer readable instructions may be executed within a processor, such as central processing unit (CPU) 91, to cause computing system 300 to operate. In many workstations, servers, and personal computers, central processing unit 91 may be implemented by a single-chip CPU called a microprocessor. In other machines, the central processing unit 91 may comprise multiple processors. Coprocessor 81 may be an optional processor, distinct from main CPU 91, that performs additional functions or assists CPU 91.

In operation, CPU 91 fetches, decodes, and executes instructions, and transfers information to and from other resources via the computer's main data-transfer path, system bus 80. Such a system bus connects the components in computing system 300 and defines the medium for data exchange. System bus 80 typically includes data lines for sending data, address lines for sending addresses, and control lines for sending interrupts and for operating the system bus. An example of such a system bus 80 is the Peripheral Component Interconnect (PCI) bus. The computing system 300 may also include a contextual summary component 98 that may automatically determine and present one or more generated summaries (e.g., textual summaries) of a resource(s). The contextual summary component 98 may facilitate presentation of the generated summary associated with the resource(s) via display 86. In some examples, the contextual summary component 98 may generate different summaries of a same resource(s) based on determining different contexts corresponding to different users which may enhance the focus and express interested key points that the different users may be interested in associated with the associated resource(s). In some examples, the contextual summary component 98 may implement a machine learning model (e.g., machine learning model(s) 630 of FIG. 6) that may be pre-trained, and/or trained in real-time, with training data (e.g., training data 620 of FIG. 6) to determine the one or more generated summaries associated with a resource(s), as described more fully below.

In some examples, the contextual summary component 98 may determine one or more summaries of a resource(s) in response to determining or receiving content input by, or associated with, one or more users (e.g., a user or a set/group of users, e.g., users in a group communication). The input may be input content or captured content by one or more user interfaces (e.g., display/touchpad/user interface(s) 42) of one or more communication devices (e.g., UEs 30). For instance, in some examples, the contextual summary component 47 may provide the content input to (or captured by) a user interface(s), by or associated with a user(s), to the contextual summary component 98 of the computer system 300. The providing of the content input to or captured by the user interface by the contextual summary component 47 to the contextual summary component 98 may enable the contextual summary component 98 to determine a summary of a resource(s). In some aspects of the present disclosure, the contextual summary component 98 may provide the determined summary of the resource(s) to one or more communication devices (e.g., UEs 30), which may present the determined summary via a user interface and/or a display (e.g., display/touchpad/user interface(s) 42).

For purposes of illustration and not of limitation, for example, the users of the communication devices may be involved in a group communication (e.g., a group chat or other group communication(s)) and the contextual summary component 98 may determine one or more topics or subjects of the group communication that may be associated with the resource(s) and may utilize the one or more determined topics/subjects, in part, to determine the summary of the resource(s). In this example, the users of the group may opt in with a network or system (e.g., network 140, system 100) to allow the computing system 300 (e.g., by the contextual summary component 98) and/or the UE 30 (e.g., by the contextual summary component 47) to determine the one or more topics/subjects associated with one or more communications of the group. The determined summary of the resource(s) may be presented via the user interfaces (e.g., display/touchpad/user interface(s) 42) of the communication devices of the users in the group communication in an instance in which the resource(s) may be uploaded for sharing and/or posted (e.g., published) within, or associated with, the group communication. In some other examples of the present disclosure, the determined summary of the resource(s) may be presented via or within a user interface(s) corresponding to a timeline/home page, for example associated with an app(s) or a feeds/news feeds, associated with the app(s), in which the determined summary of the resource(s) may be shared with other users. Additionally, as described more fully below, in some examples of the present disclosure the determined topics/subjects of the communications may be utilized as an input(s) to a machine learning model (e.g., machine learning model(s) 630) which the contextual summary component 98 may implement to perform the determining of the summaries of the resources.

Memories coupled to system bus 80 include RAM 82 and ROM 93. Such memories may include circuitry that allows information to be stored and retrieved. ROMs 93 generally contain stored data that cannot easily be modified. Data stored in RAM 82 may be read or changed by CPU 91 or other hardware devices. Access to RAM 82 and/or ROM 93 may be controlled by memory controller 92. Memory controller 92 may provide an address translation function that translates virtual addresses into physical addresses as instructions are executed. Memory controller 92 may also provide a memory protection function that isolates processes within the system and isolates system processes from user processes. Thus, a program running in a first mode may access only memory mapped by its own process virtual address space; it cannot access memory within another process's virtual address space unless memory sharing between the processes has been set up.

In addition, computing system 300 may contain peripherals controller 83 responsible for communicating instructions from CPU 91 to peripherals, such as printer 94, keyboard 84, mouse 95, and disk drive 85.

Display 86, which is controlled by display controller 96, may be used to display visual output generated by computing system 300. Such visual output may include text, graphics, animated graphics, and video. The display 86 may also include, or be associated with a user interface. The user interface may be capable of presenting one or more content items and/or capturing input of one or more user interactions associated with the user interface. Display 86 may be implemented with a cathode-ray tube (CRT)-based video display, a liquid-crystal display (LCD)-based flat-panel display, gas plasma-based flat-panel display, or a touch-panel. Display controller 96 includes electronic components required to generate a video signal that is sent to display 86.

Further, computing system 300 may contain communication circuitry, such as for example a network adaptor 97, that may be used to connect computing system 300 to an external communications network, such as network 12 of FIG. 2, to enable the computing system 300 to communicate with other nodes (e.g., UE 30) of the network.

### Exemplary System Operation

Some examples of the present disclosure may provide approaches and techniques to facilitate efficient and reliable mechanisms that provide context-aware summaries (e.g., text summaries) for resources and which may generate different summaries of the resources associated with different contexts associated with different users to enhance focus and to express interested key points or topics for the different users. In some example aspects of the present disclosure, the different contexts may be determined based, in part, on historical user interactions associated with one or more corresponding users, as described more fully below.

Some examples of the present disclosure may enable a communication device (e.g., UE 30, computing system 300) to implement a machine learning model (e.g., machine learning model(s) 730), which may determine a context associated with a user or set/group of users associated with an upload, such as for saving or loading a resource(s) to a user interface (e.g., associated with an app) for posting or publication of the resource(s) to generate a user specific/tailored summary of the resource(s). Furthermore, for a same or similar resource(s), the communication device which may implement/execute the machine learning model may generate a different summary of the same/similar resource(s) based, in part, on determining a different set of contextual data associated with, for example, a different user and/or a different set/group of users.

The communication device may present (e.g., via a display/touchpad/user interface(s) 42 and/or a display 86) the summary of the resource(s) in an instance in which the resource(s) may be uploaded (e.g., within or associated with an app) to be shared within a group (e.g., a group/set of users). In some examples, the uploading of the resource(s) may, but need not, be a post or other publication of the resource(s) within the group.

In some aspects of the present disclosure, the machine learning model(s) (e.g., machine learning model(s) 730) may utilize one or more inputs such as, for example, an impression(s) or determination(s) about the content of a resource itself and/or contextual data associated with a user(s) (also referred to herein as user contextual data). For purposes of illustration and not of limitation, as an example of the determination(s) about the content of a resource itself consider an example in which the resource(s) may be a web page. In this regard, the machine learning model(s) may utilize as an input(s) details/attributes of the web page itself in part to determine a summary associated with the web page (e.g., the resource). The attributes of the web page may include, but are not limited to, a title of the web page, contents of the web page (e.g., a summary of the web page), other details of the web page that the machine learning model may determine based on analyzing the web page itself.

Regarding the contextual data associated with a user(s) being utilized by the machine learning model(s) as an input(s), the machine learning model(s) may analyze historical data associated with a user such as, for example, one or more interactions of a user (e.g., within, or associated with, an app) over/during a predetermined time period to determine user contextual data of a user. As examples, the predetermined time period may be one or more weeks, a month(s), or any other suitable predefined time period(s). Additionally, in some examples the predetermined time period may span a time period from a prior instance of time up to a current real-time. Some examples of historical data associated with one or more interactions of a user (e.g., user historical interactions) may include, but need not be, determining the interactions associated with prior/current posts of the user, the subject matter/topic of prior/current content read by the user, prior/current likes of the user (e.g., associated with an app). In some aspects of the present disclosure, the users associated with a network or system (e.g., network 140, system 100) may opt in with the network or the system to allow the computing system 300 (e.g., by the contextual summary component 98) and/or the UE 30 (e.g., by the contextual summary component 47) to determine the user historical interactions.

For purpose of illustration and not of limitation, as an example, the machine learning model(s) may analyze the user interaction historical data associated with a user and may determine that the user read about technical documents (e.g., technical aspects of artificial intelligence (AI)) during the predetermined time period). In this regard, for example, the machine learning model(s) may determine that the user likes reading/reviewing technical documents (e.g., articles on AI) to determine what the user's focuses and/or interests include. As such, the machine learning model(s) may learn the focuses and/or interests of a user as contextual data (e.g., user contextual data) based in part on analyzing the user interaction historical data. The machine learning model(s) may utilize this contextual data in part to generate a summary of a resource(s) by determining the generated summary based on the focuses, and/or interests the user. For instance, in the example above in which the resource(s) is a web page and in an instance in which the machine learning model(s) may determine that the web page is associated with a technical paper (e.g., a paper about AI), the machine learning model(s) may generate the summary for the web page with technical details about the paper (e.g., in an instance in which the web page resource may be uploaded to be shared within an app).

In another example, for purposes of illustration and not of limitation, in an instance in which the machine learning model(s) may analyze contextual data such as user interaction historical data of a different user and may determine that the different user likes shopping, the machine learning model(s) may generate the summary for the web page with details about purchasing technology associated with the web page (e.g., purchasing technology associated with AI). As an example, in response to the machine learning model(s) being implemented/executed by a communication device (e.g., UE 30, computing system 300) may cause the communication device to present the generated summary of the resource(s) via a user interface and/or a display in an instance in which the web page resource may be uploaded to be shared (e.g., with other users of a group). In some aspects, the implementation/execution of the machine learning model(s) may be by a contextual summary component (e.g., contextual summary component 47, contextual summary component 98) of the communication device.

As such, because the context (e.g., user contextual data) may change among different users, even for a same/similar resource(s), the machine learning model(s) may generate different summaries based on the users attempting to share (e.g., upload) the resource(s). The resource may be for sharing with other users of a group (e.g., in a group chat associated with an app). In this manner, the machine learning model(s) may generate personalized, and/or user-specific tailored summaries associated with a resource(s).

In another exemplary aspect of the present disclosure, the machine learning model(s) (e.g., machine learning model(s) 730) may determine one or more topics of users based on one or more communications (e.g., messages) of users in a group. The machine learning model(s) may utilize the determined one or more topics as an input(s) to the machine learning model(s) to determine, in part, a generated summary of a resource(s). For purposes of illustration and not of limitation, as an example, the machine learning model(s) may determine that one or more communications of a group may be associated with a subject(s) or topic(s) associated with deep learning architecture technology. In this regard, the machine learning model(s) may utilize the determined subject(s) or topic(s) pertaining to deep learning architecture technology in part to automatically generate a summary associated with a resource(s). The resource(s) may be associated with, for example, an AI paper or article, as described more fully below.

In some examples, the machine learning model(s) may utilize as inputs to the machine learning model the contents about the resource(s) itself, contextual data such as the user interaction historical data of the user uploading the resource(s) for sharing with one or more other users and/or the one or more determined topics among the users in a group communication to automatically generate a summary associated with the resource(s). In some other examples, the machine learning model(s) may utilize as inputs to the machine learning model(s) the contents about the resource(s) itself and/or the one or more determined topics/subjects among the users in the group communication to automatically generate a summary associated with the resource(s).

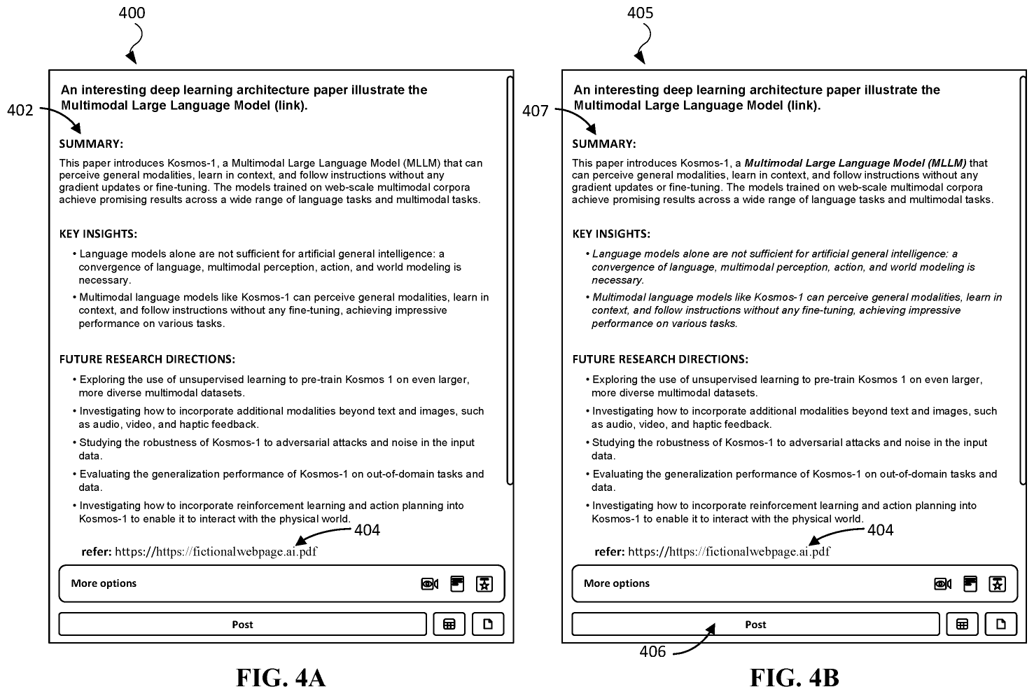

Referring now to FIG. 4A, a diagram illustrating a generated summary of a resource(s) is provided in accordance with exemplary aspects of the present disclosure. In the example of FIG. 4A, consider a scenario in which one or more users may be participating in a group communication (e.g., group messaging) and one of the users may upload a resource to be shared with one or more other users of the group. The resource may be, for example, a web page associated with an AI paper. For purposes of illustration and not of limitation, the web page may be a fictional web page such as for example https://fictionalwebpage.ai.pdf.

A contextual summary component (e.g., contextual summary component 47, contextual summary component 98) of a communication device (e.g., UE 30, computing system 300) may determine that the user which uploads the resource 404 to be shared may be interested in deep learning architecture, and/or that a topic(s)/subject(s) of the group (e.g., an audience of users) in or associated with the group communication may be interested in deep learning architect technical details. In this example, the contextual summary component, e.g., by implementing the machine learning model, may analyze the contents about the resource(s) 404 itself, contextual data such as the user interaction historical data of the user uploading the resource(s) 404 and/or one or more topics/subjects among the users in the group communication to automatically generate a summary 402 associated with the resource(s) 404 via the user interface 400. The contextual summary component may also automatically present the generated summary 402 to a user of the group via the user interface 400 (e.g., an example of display/touchpad/user interface(s) 42 or display 86) to enable the user to select a button/icon 406 or the like of the user interface 400 to post (e.g., share) the generated summary to one or more other users of the group. In this manner, the contextual summary component may automatically present the generated summary 402 to the user of the group that uploads the resource(s) 404 for sharing with one or more other users of the group to enable this user to post the generated summary 402, as well as the resource(s) 404, to the one or more other users of the group.

Referring now to FIG. 4B, another diagram illustrating another generated summary of a resource(s) is provided in accordance with exemplary aspects of the present disclosure. In the example of FIG. 4B, the contextual summary component (e.g., contextual summary component 47, contextual summary component 98) may automatically determine another generated summary 407 which may be in a different format from a format of the generated summary 402 associated with the resource(s) 404. In some examples, the generated summary 407 may be an alternative generated summary to the generated summary 402. The alternate generated summary 407 may be presented within a user interface 405. The generated summary 407 may illustrate that the contextual summary component may determine the generated summary 407 in a different format for a same resource(s) 404 based on a user context for example associated with a different writing behavior, style, tone, etc. of the user uploading the resource(s) 404 in relation to a determined different user context associated with the generated summary 402. In this manner, the contextual summary component may automatically provide diverse generated summaries even for the same or similar resource(s). In some examples, the contextual summary component (e.g., contextual summary component 47, contextual summary component 98) may present the alternate generated summary 407 in response to an expiration of a predetermined time period in an instance in which a user may not select to post the generated summary 402.

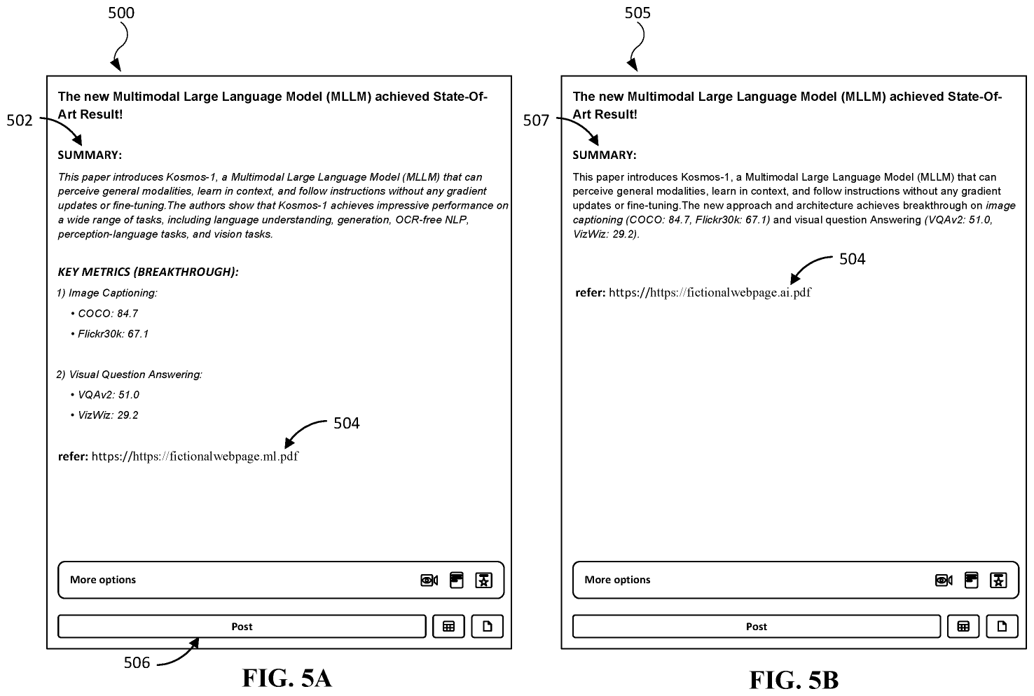

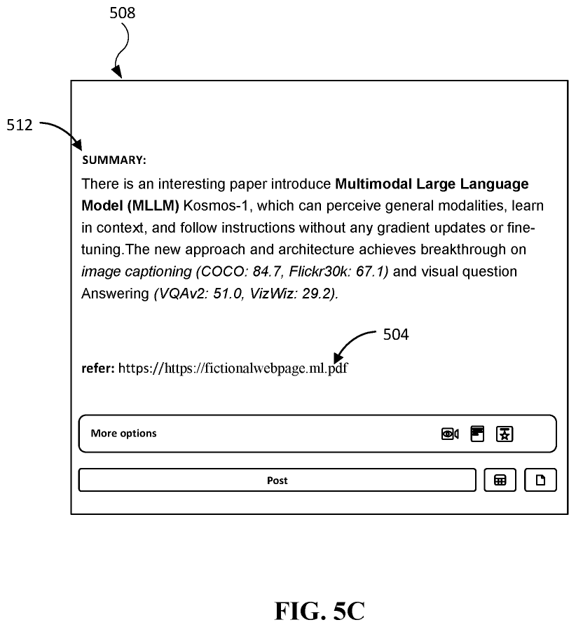

Referring now to FIG. 5A, a diagram illustrating a generated summary of a resource(s) is provided in accordance with exemplary aspects of the present disclosure. In the example of FIG. 5A, consider a scenario in which one or more users may be participating in a group communication (e.g., group messaging) and one of the users may upload a resource to be shared with one or more other users of the group. The resource(s) may be, for example, a web page associated with a machine learning (ML) or AI paper. For purposes of illustration and not of limitation, the web page may be a fictional web page such as for example https://fictionalwebpage.ml.pdf.

A contextual summary component (e.g., contextual summary component 47, contextual summary component 98) of a communication device (e.g., UE 30, computing system 300) may determine that the user which uploads the resource(s) 504 to be shared may be interested in advanced ML progress/status in an industry, and/or that one or more topics of the group (e.g., an audience of users) in or associated with the group communication may be interested in the status of current AI technology, and these users of the group may not care about or be interested in technology details. For example, the users of the group may not be interested in deep learning architecture technology details (e.g., unlike one or more users of the group described in relation to FIG. 4A). In this example, the contextual summary component, e.g., by implementing the machine learning model, may analyze the contents about the resource(s) 504 itself, the user interaction historical data of the user uploading the resource(s) 504 and/or one or more topics/subjects among the users in the group communication to determine the user interest(s) in advanced ML progress/status in an industry and to utilize this user interest(s) in part to automatically generate a summary 502 associated with the resource(s) 504 via the user interface 500.

The contextual summary component may also automatically present the generated summary 502 to a user of the group via the user interface 500 (e.g., an example of display/touchpad/user interface(s) 42 or display 86) to enable the user to select a button/icon 506 or the like of the user interface 500 to post (e.g., share) the generated summary 502 to one or more other users of the group. Other aspects of the generated summary 502 of the example of FIG. 5A may be similar to the operation of FIG. 4A, described above, in relation to the generated summary 402.

Referring now to FIG. 5B, another diagram illustrating another generated summary of a resource(s) is provided in accordance with exemplary aspects of the present disclosure. In the example of FIG. 5B, the contextual summary component (e.g., contextual summary component 47, contextual summary component 98) may automatically determine another generated summary 507 which may be in a different format with different content items in relation to a format and items of content of the generated summary 502 associated with the resource(s) 504. In some examples, the generated summary 507 may be an alternate generated summary in relation to the generated summary 502. The alternate generated summary 507 may be presented within a user interface 505. The generated summary 507 may illustrate that the contextual summary component may generate the generated summary 507 in a different format for a same resource(s) 504 based on a user context for example associated with a different writing behavior, style, tone, etc. of the user uploading the resource(s) 504 in relation to a determined different user context associated with the generated summary 502. In this manner, the contextual summary component may automatically provide diverse generated summaries even for the same or similar resource(s).

Referring now to FIG. 5C, yet another diagram illustrating another generated summary of a resource(s) is provided in accordance with exemplary aspects of the present disclosure. In the example of FIG. 5C, the contextual summary component (e.g., contextual summary component 47, contextual summary component 98) may automatically determine another/alternate generated summary 512 which may have content items that may be briefer or shorter and/or may be in a different format in relation to the format and/or data items of the generated summary 502 associated with the same resource(s) 504 (e.g., a web page associated with a ML or AI paper). The generated summary 512 may be provided/presented, by the contextual summary component, in a user interface 508.

The generated summary 512 may illustrate that the contextual summary component may generate the generated summary 512 in a more concise manner (e.g., briefer or shorter) and/or in a different format for a same resource(s) 504 based on a user context for example associated with a different writing behavior, style, tone, etc. of the user uploading the resource(s) 504 in relation to a determined different user context(s) associated with the generated summary 502 and/or the generated summary 507. For purposes of illustration and not of limitation, in some examples, the contextual summary component (e.g., contextual summary component 47, contextual summary component 98) may generate the generated summary 512 in an instance in which a user may not select or accept (e.g., to post) the generated summary 507 prior to an expiration of a predetermined time period (e.g., 15 seconds, 20 seconds, etc.).

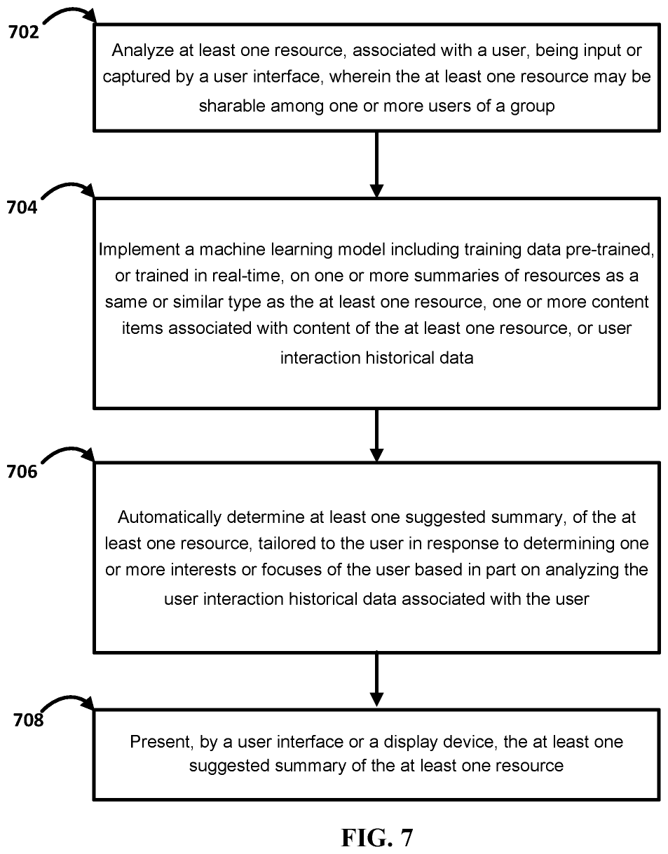

FIG. 6 illustrates an example of a machine learning framework 600 including machine learning model(s) 630 and a training database 650, in accordance with one or more examples of the present disclosure. The training database 650 may store training data 620. In some examples, the machine learning framework 600 may be hosted locally in a computing device or hosted remotely. By utilizing the training data 620 of the training database 650, the machine learning framework 600 may train the machine learning model(s) 630 to perform one or more functions, described herein, of the machine learning model(s) 630. In some examples, the machine learning model(s) 630 may be stored in a computing device. For example, the machine learning model(s) 630 may be embodied within a communication device (e.g., UE 30). In some other examples, the machine learning model(s) 630 may be embodied within another device (e.g., computing system 300). Additionally, the machine learning model(s) 630 may be processed by one or more processors (e.g., processor 32 of FIG. 2, coprocessor 81 of FIG. 3). In some examples, the machine learning model(s) 630 may be associated with operations (or performing operations) of FIG. 7. In some other examples, the machine learning model(s) 630 may be associated with other operations.

In an example, the training data 620 may include attributes of thousands of objects. For example, the objects may be posters, brochures, billboards, menus, goods (e.g., packaged goods), books, groceries, Quick Response (QR) codes, smart home devices, home and outdoor items, household objects (e.g., furniture, kitchen appliances, etc.) and any other suitable objects. In some other examples, the objects may be smart devices (e.g., UEs 30, communication devices 105, 110, 115, 120), persons (e.g., users), newspapers, articles, flyers, pamphlets, signs, cars, content items (e.g., messages, notifications, images, videos, audio), and/or the like. Attributes may include, but are not limited to, the size, shape, orientation, position/location of the object(s), etc. The training data 620 employed by the machine learning model(s) 630 may be fixed or updated periodically. Alternatively, the training data 620 may be updated in real-time based upon the evaluations performed by the machine learning model(s) 630 in a non-training mode. This may be illustrated by the double-sided arrow connecting the machine learning model(s) 630 and stored training data 620. Some other examples of the training data 620 may include, but are not limited to, items of content determined as being associated with a network (e.g., the Internet, a social network, etc.). The items of content may be analyzed, by a communication device (e.g., computing system 300, UE 30), to determine one or more previously generated summaries associated with one or more corresponding resources (e.g., prior uploads or posts of summaries of resources for sharing among users). These items of content associated with summaries of resources may be provided as a subset of the training data 620 to the training database 650 and may be utilized, in part, to pre-train, and/or train in real-time, the machine learning model(s) 630. Additionally, other content items such as, for example, prior or currently (e.g., in real-time) determined information about the contents of a detected resource(s) itself (e.g., to be shared) as described above, contextual data such as user interaction historical data associated with the interests and/or focuses of a user(s) as described above and/or one or more determined topics or subjects of communications (e.g., messages) of a group communication as described above may be another subset of the training data 620. A set of users may be part of a group associated with the group communication. In this regard, in an instance in which the machine learning model(s) 630 may detect or identify a resource(s) in, or associated with, the training data 620 and may determine that the resource(s) is of a same or similar type as a resource(s) being analyzed (e.g., in an upload or post), the machine learning model(s) 630 may automatically determine a suggested summary of the resource(s) being analyzed. In this regard, in some examples of the present disclosure, the machine learning model(s) 630 may facilitate output/presentation (e.g., via a user interface, a display, etc.) of the automatically determined suggested summary of the resource(s) being analyzed.

In some examples, a component (e.g., contextual summary component 47, contextual summary component 98) and/or a device (e.g., UE 30, computing system 300) may implement the machine learning model(s) 630 to automatically determine the suggested summary of the analyzed resource(s). The automatically generated summary of a resource(s) may be textual and/or may include text that may include one or more alphanumeric characters, The alphanumeric characters may include, but are not limited to, alphabetic characters, numeric characters, punctuation, symbols and/or the like. In some examples, the training data 620 may be synthetic data, and/or content associated with a network (e.g., the Internet), as described above, such as for example content based on one or more web pages, and/or content based on attributes (e.g., posters, etc.) as described above. The machine learning framework 600 may take raw text such as, for example, written or captured text of a user input/captured by a composer, other content or media (e.g., multimedia content such as for example videos, pictures/images, etc.) as the input for the machine learning model(s) 630, and a rendering visualization of the raw text, other content or media may be generated by the machine learning framework 600 as results (e.g., one or more labels) for/associated with the training data 620. The machine learning model(s) 630 may be able to learn from the training data 620 (e.g., the input text, content, media) to predict or determine the output (e.g., a summary of a determined resource(s)) to render as one or more results.

In some examples, the synthetic data may, but need not, be modified/changed to certain content that may be marked based on a tag/format or the like from data associated with for example a user(s) that may have edited or created this data to enable the machine learning framework 600 to form/generate new data examples. In this manner, the machine learning framework 600 may have diversity and may include many more datasets for the training data 620.

By utilizing the example aspects of the present disclosure providing artificial intelligence and/or machine learning approaches/techniques to automatically generate contextual summaries for a resource(s) may enable provision of a more robust, efficient and user friendly composer (e.g., editor) for users to engage with for user interaction and provision/sharing of content than conventional/existing approaches that may require brute force approaches such as causing a user to manually click and read content of a resource to learn and figure out whether there is any useful information the user may be interested in regarding the resource since, as described above, the conventional/existing approaches may typically create the same/similar summary of a resource (e.g., within a composer) for all users. The composer (e.g., editor) of the example aspects of the present disclosure may provide technical improvements for the field of user interface interaction technology (e.g., graphical user interfaces) as well as improvements for communication devices by enhancing and improving efficient operation of communication devices based on minimizing/conserving memory space of memory devices and processing resources of communication devices associated with presentation/rendering of a user interface with automatic generated contextual summaries of a resource(s) based on data associated with a user (e.g., user interaction data). In this regard, the automatic generated contextual summaries of a resource(s), generated by the example aspects of the present disclosure, may be specific and tailored to different users.

For example, automated contextual summaries of a resource(s) based on the example aspects of the present disclosure may reduce the time and/or processing resources to generate contextual summaries of a resource(s) within a composer to share such contextual summaries with other users since such automated contextual summaries of a resource(s) may reduce/minimize conservation of computing resources (e.g., processing resources (e.g., processor 32, co-processor 81)) of a communication device in relation to conventional/existing brute force manual approaches of users accessing (e.g., by clicking) through and reviewing/reading aspects of content of a resource to determine whether a created summary that is non-specific to users is relevant to the particular user that may be desiring to share the resource with other users. The conventional/existing approaches and/or systems may require significantly more computation of computing resources (than the approaches of the example aspects of the present disclosure) in order to perform the manual inputs/approaches by a user associated with accessing and reviewing aspects of content of a resource to determine whether a created summary is relevant to the user. In addition, the example aspects of the present disclosure may conserve memory space of memory devices (e.g., non-removable memory 44, removable memory 46, RAM 82, ROM 93) by not causing additional storage of inputs by memory devices associated with data pertaining to steps (e.g., manual selections associated content access and review of a resource) taking place to enable a user to manually determine the relevance of a summary associated with a resource, within a composer, that the user may desire to share with other users. In addition, the diversity of the automated generated contextual summaries of a resource(s) determined by the example aspects of the present disclosure that may be tailored for a specific user(s) may reduce/minimize the size of the automated generated contextual summaries of the resource(s) for communication across a network, which may facilitate conservation of bandwidth, based on reducing network traffic, across the network (e.g., network 140) and thereby conserves network resources. The example aspects of the present disclosure may reduce/minimize the size of the automated generated contextual summaries of a resource(s) since the automated summary of the resource(s) may be tailored for a specific user. In some examples, the communication of the automated generated contextual summaries of the resource(s) across the network may be by sharing/providing an automated generated contextual summary of a resource(s) from a communication device (e.g., a UE 30) of a user to communication devices (e.g., other UEs 30) of one or more other users.

FIG. 7 illustrates an example flowchart illustrating operations for providing generating suggested summaries of a resource(s) according to an example of the present disclosure. At operation 702, a device (e.g., UE 30, computing system 300) may analyze at least one resource (e.g., resource(s) 404), associated with a user, being input or captured by a user interface (e.g., user interface 400). The at least one resource may be sharable among one or more users of a group. At operation 704, a device (e.g., UE 30, computing system 300) may implement a machine learning model (e.g., machine learning model(s) 630). The machine learning model may include training data (e.g., training data 620) pre-trained, or trained in real-time, on one or more summaries of resources as a same or similar type as the at least one resource, one or more content items associated with content of the at least one resource, or user interaction historical data. In some other examples, the machine learning model may further include training data pre-trained, or trained in real-time on, for example, one or more determined topics or subjects associated with one or more communications of the one or more users of the group. In some examples, the communications may be messages (e.g., text messages, multimedia messages, etc.). In some aspects, the user may also be part of the users of the group.

At operation 706, a device (e.g., UE 30, computing system 300) may automatically determine at least one suggested summary (e.g., the at least one suggested summary 402), of the at least one resource (e.g., resource(s) 404). The determined at least one suggested summary of the resource may be tailored to the user in response to determining one or more interests or focuses of the user based in part on analyzing the user interaction historical data (e.g., associated with the user). In some other examples, the determined at least one suggested summary of the resource may also be tailored to the user in response to determining one or more interests or focuses of the user based on determining that the at least one resource includes a same or similar type of resource as a corresponding resource associated with, or within, the training data (e.g., training data 620). At operation 708, a device (e.g., UE 30, computing system 300) may present, by a user interface or a display device, the at least one suggested summary of the at least one resource. In some examples, the user interface or the display device may be a display/touchpad/user interface(s) 42 or a display 86.

### Alternative Embodiments

The foregoing description of the embodiments has been presented for the purpose of illustration; it is not intended to be exhaustive or to limit the patent rights to the precise forms disclosed. Persons skilled in the relevant art can appreciate that many modifications and variations are possible in light of the above disclosure.

Some portions of this description describe the embodiments in terms of applications and symbolic representations of operations on information. These application descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as components, without loss of generality. The described operations and their associated components may be embodied in software, firmware, hardware, or any combinations thereof.

Any of the steps, operations, or processes described herein may be performed or implemented with one or more hardware or software components, alone or in combination with other devices. In one embodiment, a software component is implemented with a computer program product comprising a computer-readable medium containing computer program code, which can be executed by a computer processor for performing any or all of the steps, operations, or processes described.

Embodiments also may relate to an apparatus for performing the operations herein. This apparatus may be specially constructed for the required purposes, and/or it may comprise a computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments also may relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed:

1. A method comprising:
analyzing at least one resource, associated with a user, being input or captured by a user interface, wherein the at least one resource is sharable among one or more other users of a group;
implementing a machine learning model comprising training data pre-trained, or trained in real-time, on one or more summaries of resources as a same or similar type as the at least one resource, one or more content items associated with content of the at least one resource, or user interaction historical data;
automatically determining at least one suggested summary, of the at least one resource, tailored to the user in response to determining one or more interests or focuses of the user based in part on analyzing the user interaction historical data; and
presenting, by a user interface or a display device, the at least one suggested summary of the at least one resource.

2. The method of claim 1, further comprising:
training the training data pre-trained, or in real-time, further on one or more determined topics or subjects associated with one or more communications of the one or more users of the group; and
the automatically determining the at least one suggested summary of the at least one resource tailored to the user further in response to determining the one or more determined topics or subjects.

3. The method of claim 1, further comprising:
automatically determining at least one other suggested summary, of the at least one resource, tailored to a second user among the one or more other users of the group in response to determining one or more other interests or other focuses of the second user based in part on analyzing the user interaction historical data associated with the second user.

4. The method of claim 3, wherein:
content items of the at least one suggested summary of the at least one resource and items of content of the at least one other suggested summary of the at least one resource are different.

5. The method of claim 1, further comprising:
performing the automatically determining the at least one suggested summary of the at least one resource in an instance in which the user interface captures input of the at least one resource to be shared with the one or more users of the group.

6. The method of claim 5, wherein:
the user interface captures the input comprises one or more of an upload of the at least one resource to the user interface by the user or an option to post or publish the at least one resource by the user interface in response to the user interface detecting the at least one resource.

7. The method of claim 1, further comprising:
generating an alternative summary of the at least one resource tailored to the user based on determining at least one of a writing behavior of the user, a typing behavior of the user, a style of the user or a tone of the user.

8. The method of claim 7, wherein:
at least one format or one or more content items of the at least one suggested summary of the at least one resource is different from at least a second format or one or more data items of the alternative summary of the at least one resource.

9. The method of claim 1, further comprising:
performing the automatically determining the at least one suggested summary of the at least one resource based on determining that the at least one resource comprises a same or similar type of resource as a corresponding resource associated with, or within, the training data,
wherein the user interaction historical data is obtained during a predetermined time period.

10. An apparatus comprising:
one or more processors; and
at least one memory storing instructions, that when executed by the one or more processors, cause the apparatus to:
analyze at least one resource, associated with a user, being input or captured by a user interface, wherein the at least one resource is sharable among one or more other users of a group;
implement a machine learning model comprising training data pre-trained, or trained in real-time, on one or more summaries of resources as a same or similar type as the at least one resource, one or more content items associated with content of the at least one resource, or user interaction historical data;
automatically determine at least one suggested summary, of the at least one resource, tailored to the user in response to determining one or more interests or focuses of the user based in part on analyzing the user interaction historical data; and
present, by a user interface or a display device, the at least one suggested summary of the at least one resource.

11. The apparatus of claim 10, wherein when the one or more processors execute the instructions, the apparatus is configured to:
train the training data pre-trained, or in real-time, further on one or more determined topics or subjects associated with one or more communications of the one or more users of the group; and
perform the automatically determine the at least one suggested summary of the at least one resource tailored to the user further in response to determining the one or more determined topics or subjects.

12. The apparatus of claim 10, wherein when the one or more processors execute the instructions, the apparatus is configured to:
automatically determine at least one other suggested summary, of the at least one resource, tailored to a second user among the one or more other users of the group in response to determining one or more other interests or other focuses of the second user based in part on analyzing the user interaction historical data associated with the second user.

13. The apparatus of claim 12, wherein:
content items of the at least one suggested summary of the at least one resource and items of content of the at least one other suggested summary of the at least one resource are different.

14. The apparatus of claim 10, wherein when the one or more processors execute the instructions, the apparatus is configured to:
perform the automatically determine the at least one suggested summary of the at least one resource in an instance in which the user interface captures input of the at least one resource to be shared with the one or more other users of the group.

15. The apparatus of claim 14, wherein:
the user interface captures the input comprises one or more of an upload of the at least one resource to the user interface by the user or an option to post or publish the at least one resource by the user interface in response to the user interface detecting the at least one resource.

16. The apparatus of claim 10, wherein when the one or more processors execute the instructions, the apparatus is configured to:
generate an alternative summary of the at least one resource tailored to the user based on determining at least one of a writing behavior of the user, a typing behavior of the user, a style of the user or a tone of the user.

17. The apparatus of claim 16, wherein:
at least one format or one or more content items of the at least one suggested summary of the at least one resource is different from at least a second format or one or more data items of the alternative summary of the at least one resource.

18. The apparatus of claim 10, wherein when the one or more processors execute the instructions, the apparatus is configured to:
perform the automatically determining the at least one suggested summary of the at least one resource based on determining that the at least one resource comprises a same or similar type of resource as a corresponding resource associated with, or within, the training data,
wherein the user interaction historical data is obtained during a predetermined time period.

19. A non-transitory computer-readable medium storing instructions that, when executed, cause:
analyzing at least one resource, associated with a user, being input or captured by a user interface, wherein the at least one resource is sharable among one or more other users of a group;
implementing a machine learning model comprising training data pre-trained, or trained in real-time, on one or more summaries of resources as a same or similar type as the at least one resource, one or more content items associated with content of the at least one resource, or user interaction historical data;
automatically determining at least one suggested summary, of the at least one resource, tailored to the user in response to determining one or more interests or focuses of the user based in part on analyzing the user interaction historical data; and
presenting, by a user interface or a display device, the at least one suggested summary of the at least one resource.

20. The computer-readable medium of claim 19, wherein the instructions, when executed, further cause:
automatically determining at least one other suggested summary, of the at least one resource, tailored to a second user among the one or more other users of the group in response to determining one or more other interests or other focuses of the second user based in part on analyzing the user interaction historical data associated with the second user.
